(19) United States
(12) Patent Application Publication
(10) Pub. No.: US 2024/0233425 A1
(43) Pub. Date: Jul. 11, 2024

(54) APPLIANCE AND METHOD FOR IMAGE PROCESSING

(71) Applicant: Haier US Appliance Solutions, Inc., Wilmington, DE (US)

(72) Inventor: Sarah Virginia Morris, Louisville, KY (US)

(21) Appl. No.: 18/095,834

(22) Filed: Jan. 11, 2023

(51) Int. Cl. G06V 30/19; G06T 7/70; G06V 10/60; G06V 10/75; H04L 9/32; H04N 1/40

(52) U.S. Cl. CPC G06V 30/19093; G06T 7/70; G06V 10/60; G06V 10/751; H04L 9/3236; H04N 1/40012; G06T 2207/10024

(57) ABSTRACT

An appliance and a system configured to execute a method for image processing is provided. The method includes acquiring, via an imaging device, an image and determining, from the image, an image identifier including a plurality of alphanumeric characters. The method compares the image identifier with each of a plurality of configuration identifiers stored at the memory device and determines which configuration identifier corresponds to the image identifier based on comparing a quantity of positions at the image identifier that are different from each configuration identifier.

### FIELD

The present disclosure generally pertains to appliances, and more particularly to methods for image processing at an appliance.

### BACKGROUND

Apparatuses that include cameras may capture and store images that can be processed through computing algorithms to extract desired information. However, capturing and storing images in a computing device, such as a network or cloud computing environment, may be prohibitively expensive or computationally cumbersome. Such cost and computational limitations may further limit or prohibit implementing acquisition and control methods when cameras are applied to appliances, such as cooking apparatuses or refrigeration apparatuses.

Appliances, such as cooking and refrigeration apparatuses, generally include limited computing capacity and memory. Accordingly, methods and algorithms that generate large files for storage or transmission may be unsuitable for appliances. Alternatively, methods and algorithms having insufficient data acquisition may be inhibited from being utilized for appliances.

As such, there is a need for appliances and methods for image processing at an appliance.

### BRIEF DESCRIPTION

Aspects and advantages of the invention will be set forth in part in the following description, or may be obvious from the description, or may be learned through practice of the invention.

An aspect of the present disclosure is directed to an appliance. The appliance includes a plurality of walls forming a chamber and an imaging device configured with a field of view including at least a portion of the chamber. A controller is in operable communication with the imaging device and includes a processor operably coupled to a memory device. The memory device is configured to store instructions that, when executed by the processor, causes the appliance to perform operations. The operations include acquiring, via the imaging device, an image and determining, from the image, an image identifier comprising a plurality of alphanumeric characters. The operations include comparing the image identifier with each of a plurality of configuration identifiers stored at the memory device, and determining which configuration identifier corresponds to the image identifier based on comparing a quantity of positions at the image identifier that are different from each configuration identifier.

Another aspect of the present disclosure is directed to a system for image processing at an appliance. The system includes a controller in operable communication with an imaging device configured with a field of view of at least a portion of a chamber at the appliance. The controller includes a processor operably coupled to a memory device and configured to store instructions that, when executed by the processor, causes the appliance to perform operations. The operations include acquiring, via the imaging device, an image and determining, via a hash function, an image identifier from the image. The operations include determining a hamming distance between the image identifier and each of a plurality of configuration identifiers stored at the memory device, and determining, based on the hamming distance, which configuration identifier corresponds to the image identifier.

Yet another aspect of the present disclosure is directed to a method for image processing at an appliance. The method includes acquiring an image and determining an image identifier from the image, the image identifier including a plurality of alphanumeric characters. The method includes comparing the image identifier with each of a plurality of configuration identifiers stored at the memory device, and determining which configuration identifier corresponds to the image identifier based on comparing a quantity of positions at the image identifier that are different from each configuration identifier.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary cooking appliance in accordance with aspects of the present disclosure;

FIG. 2 provides a perspective view of the exemplary cooking appliance of FIG. 1 including portions of which are transparent to depict certain details in accordance with aspects of the present disclosure;

FIG. 3 provides a front view of an exemplary refrigerator appliance with doors open in accordance with aspects of the present disclosure;

FIG. 4 provides a schematic embodiment of a computing device for an appliance in accordance with aspects of the present disclosure;

FIG. 5 provides a schematic embodiment of a communication system in accordance with aspects of the present disclosure; and

FIG. 6 provides a flowchart outlining steps of a method for image processing at an appliance in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

Embodiments of an appliance and a method for image processing are provided. Embodiments provided herein include an imaging device configured with a field of view including at least a portion of a heat transfer chamber, such as a cooking chamber at an cooking appliance (e.g., kitchen oven, oven-stove, microwave oven, toaster oven, air fryer, etc.) or a cooling compartment of a refrigeration appliance or freezer appliance. The chamber may generally include one or more racks at which food or other items may be placed. The chamber may furthermore include a plurality of locations at which the rack may be positioned (e.g., different rack heights within the chamber). The imaging device is configured to capture an image of the rack(s) at the chamber. A local computing device, such as a processor at the appliance, is configured to acquire the image and convert it to an alphanumeric identifier (i.e., an identifier including numbers, alphabets, or combinations thereof) corresponding to properties of the image. The computing device compares the alphanumeric identifier to a plurality of configuration identifiers stored at the computing device. The configuration identifier corresponds to predetermined rack mount configurations at the chamber (e.g., rack mounted at a top position, bottom position empty; rack mounted at a bottom position, top position empty; rack mounted at a top position and a bottom position; rack mounted at neither the top position nor the bottom position; combinations of two or more racks at two or more possible positions; etc.). The computing device determines which configuration identifier corresponds to the image via comparison to the alphanumeric identifier.

Matching the configuration identifier to the image allows the computing device to determine the rack mount configuration at the oven. The computing device may generate, transmit, or otherwise obtain a signal corresponding to the determined configuration identifier. The determined configuration of rack(s) at the chamber may allow the computing device to more accurately or precisely determine or modify a heating cycle, cooling cycle, or flow profile within the chamber (e.g., via adjusting heat input or removal, adjusting fluid flow rate, or other factor that may affect heat transfer at the chamber).

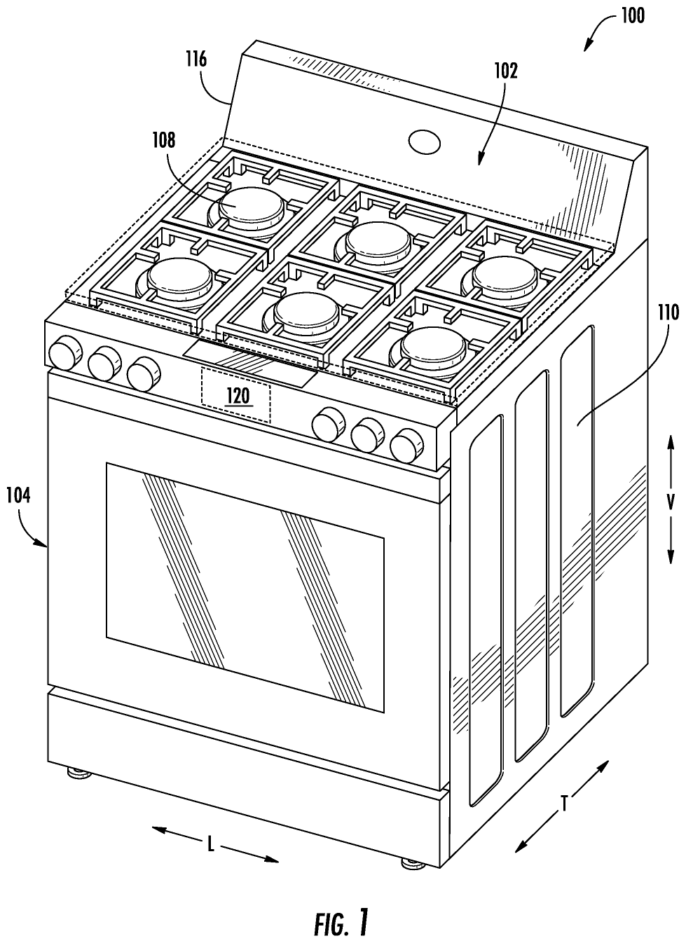

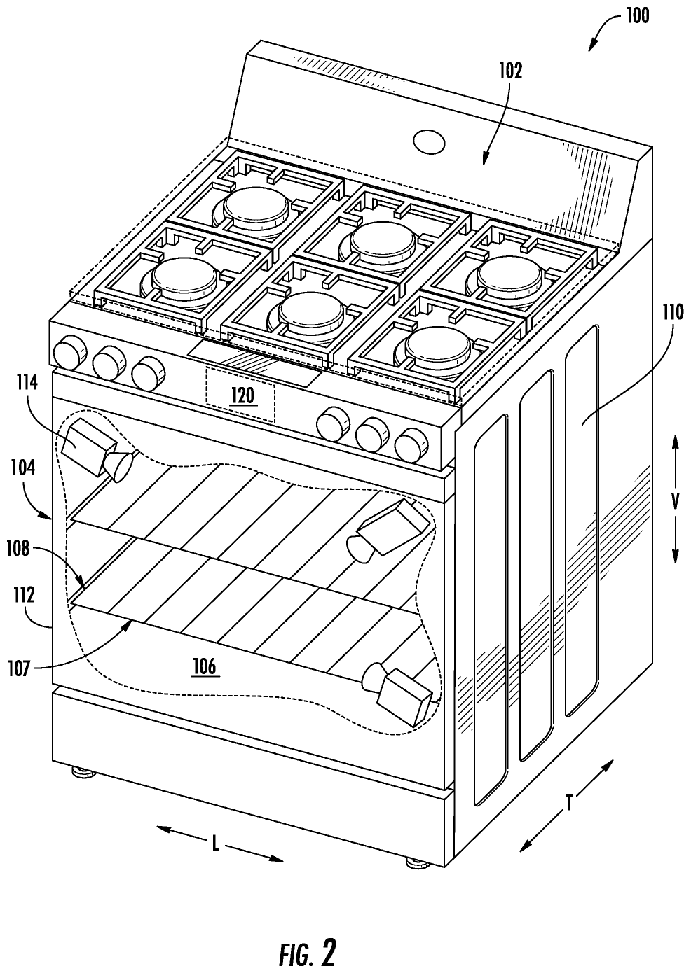

Referring now to the drawings, FIGS. 1-2 provide an exemplary embodiment of an appliance 100 in accordance with aspects of the present disclosure. Appliance 100 depicted in FIGS. 1-2 includes an oven appliance 104. In some embodiments, appliance 100 may include one or more heating elements at a cooktop appliance 102. Various embodiments of the heating element are configured to release thermal energy or heat to cook foodstuffs positioned at a chamber. Various embodiments of cooking chamber generally include a chamber 106 at the oven appliance 104. Appliance 100 generally includes walls or panels 110 at least partially forming the chamber 106, such as to form a cooking chamber for the oven appliance 104. Panels 110 may further form a structure at which cooktop appliance 102 is positioned atop. A door 112 is rotatably attached to panel 110 to allow access into the chamber 106.

One or more racks 107 is positioned at a rack mount 108 within the chamber 106. The appliance 100 may include any combination of racks 107 at rack mounts 108. For instance, the rack 107 may be mounted at a top rack mount 108 and a bottom rack mount may be empty, the rack 107 may be mounted at a bottom rack mount 108 and a top rack mount may be empty; respective racks 107 may be mounted at the top and bottom rack mounts 108; or no rack mounted at any rack mount position; or any other combinations of two or more racks 107 at two or more rack mount 108. Although depicted as two rack mounts 108, it should be appreciated that the appliance 100 may include three or more rack mounts 108, or four or more rack mounts 108, etc. Still further, although depicted as two racks 107, it should be appreciated that the appliance 100 may include one or more racks 107, or two or more racks 107, or three or more racks 107, or equal or lesser quantities of racks 107 to rack mounts 108.

In various embodiments, appliance 100 includes an imaging device 114 configured with a field of view including at least a portion of the chamber 106. In particular, the imaging device 114 is configured to acquire images or data of the rack 107 and the rack mount 108 within the chamber 106. The imaging device includes any appropriate mechanism configured to capture or acquire visual images or data substantially corresponding to a visual image. The imaging device 114 may capture images in visible light spectrum, infrared light, or other ranges of spectrum. As further provided herein, images or corresponding data from the imaging device 114 is acquired and provided to a computing device 120. In various embodiments, the imaging device 114 is positioned at or within the oven chamber 106. Additionally, or alternatively, the imaging device 114 may be positioned outside of the oven chamber 106. In still various embodiments, the imaging device 114 may be configured with a field of view including at least a portion of the oven chamber 106, such as including the rack(s) 107 and rack mount(s) 108. For instance, door 112 may include a transparent opening through which imaging device 114 may capture images of racks within the oven chamber 106.

Although a particular embodiment of an appliance 100 is provided, it should be appreciated that embodiments of the method and communication system further described herein may be applied or executed at standalone cooktop appliances, standalone oven appliances, air fryers, induction cooking devices, grills, open flames, fire pits, pressure cookers, or other cooking devices including one or more racks 107 and a plurality of rack mount 108 positions.

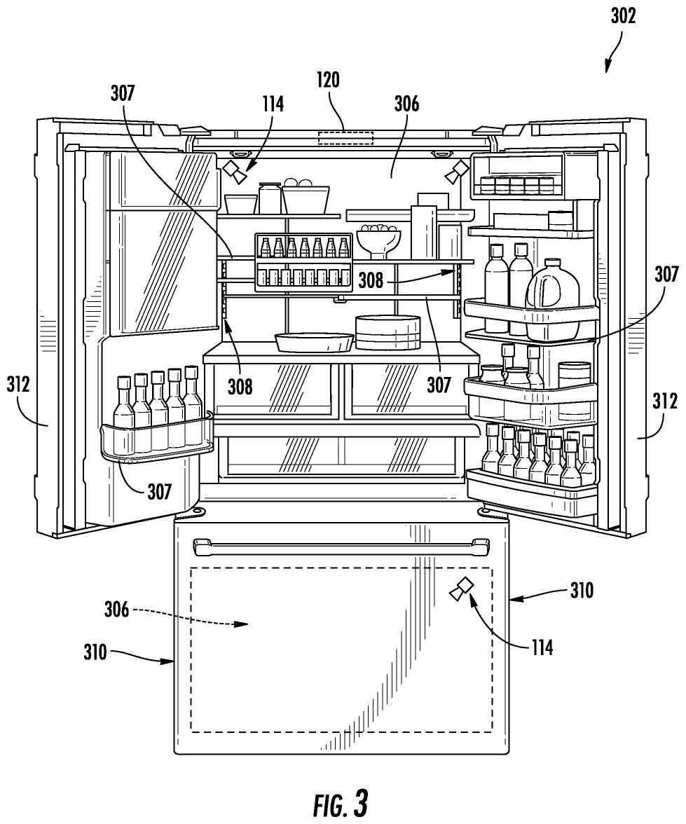

Referring to FIG. 3, an exemplary embodiment of the appliance 100 in accordance with aspects of the present disclosure is provided. Appliance 100 depicted in FIG. 3 is configured as a refrigeration appliance, a freezer appliance, or both. Appliance 100 generally includes walls or panels 310 at least partially forming a chamber 306, such as to form a refrigeration compartment or a freezer compartment. One or more doors 312 is rotatably or slidably attached to panel 310 to allow access into the chamber 306.

One or more racks 307 is positioned at a rack mount 308 within the chamber 306. The appliance 100 may include any combination of racks 307 at rack mounts 308. For instance, the rack 307 may be mounted on rack mounts 308 at interior portions of the panels 310 at the chamber 306. The rack 307 may be mounted on rack mounts at interior portions of doors 312 at the chamber 306. In various embodiments, the appliance 100 includes two or more positions at which the racks 307 may be mounted, such as described in regard to the appliance 100. As described in regard to appliance 100, the appliance 100 includes one or more imaging devices 114 configured with a field of view including at least a portion of the chamber 306. The imaging device 114 is configured to acquire images or data of the rack 307 and the rack mount 308 within the chamber 306.

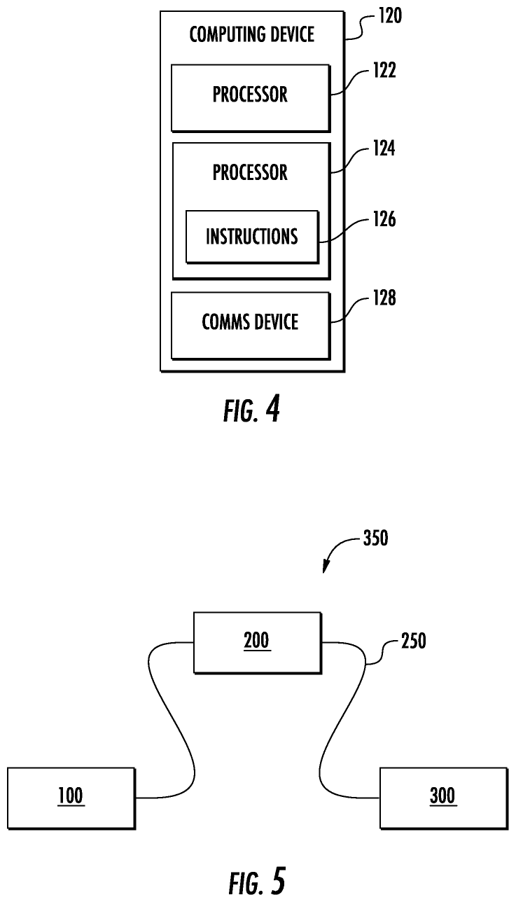

Referring now to FIG. 4, a schematic embodiment of a computing device 120 is provided. Embodiments of the appliance 100 may include the computing device 120. The computing device 120 may include a processor 122, a memory device 124, and a communications device 128. The memory device 124 is configured to receive instructions 126 that, when executed by the processor 122, causes the appliance 100 to perform operations. The communications device 128 provides a wired or wireless communications bus to send and/or receive signals, such as control signals or control commands as further described herein.

As used herein, the term “processor” refers not only to integrated circuits referred to in the art as being included in a computer, but also refers to a controller, microcontroller, a microcomputer, a programmable logic controller (PLC), an application specific integrated circuit (ASIC), a Field Programmable Gate Array (FPGA), and other programmable circuits. Additionally, the memory device may generally include memory element(s) including, but not limited to, computer readable medium (e.g., random access memory (RAM)), computer readable non-volatile medium (e.g., flash memory), or other suitable memory elements or combinations thereof.

Referring now to FIG. 5, a schematic diagram of a communication system 350 will be described according to an exemplary embodiment of the present subject matter. In general, communication system 350 is configured for permitting interaction, data transfer, and other communications between appliance 100 and one or more external devices 300. For example, this communication may be used to transmit and receive images or corresponding data, control signals, control commands, user instructions or notifications, or any other suitable information for operating the appliance 100 or processing an image acquired by the imaging device 114. In a particular embodiment, the external device 300 may command execution of one or more steps of a method for image processing at the appliance 100, such as steps of a method 1000 provided further herein.

For example, communication system 350 permits computing device 120 to communicate with a separate external device 300, i.e., external to appliance 100. Such communications may be facilitated using a wired or wireless connection, such as via a network 250, e.g., a cloud computing system or distributed network of computing devices. In general, external device 300 may be any suitable device separate from appliance 100 that is configured to transmit and/or receive communications, information, data, or commands. In this regard, external device 300 may be, for example, a personal phone, a smartphone, a tablet, a laptop or personal computer, a wearable device, a smart home system, or other remote computing device.

In addition, a remote server 200 may be in communication with appliance 100 and/or external device 300 through the network 250. In this regard, for example, remote server 200 may be a cloud-based server, and is thus located at a distant location, such as in a separate building, city, state, country, etc., or generally elsewhere from the appliance 100. According to an exemplary embodiment, external device 300 may communicate with the remote server 200 over network 250, such as the Internet, to transmit/receive data, information, images, control signals, control commands, or signals generally corresponding to one or more steps of the method such as provided herein. In addition, external device 300 and remote server 200 may communicate with appliance 100 to communicate similar information.

In general, communication between appliance 100, external device 300, remote server 200, and/or other user devices may be carried using any type of wired or wireless connection and using any suitable type of communication network, non-limiting examples of which are provided below. For example, external device 300 may be in direct or indirect communication with appliance 100 through any suitable wired or wireless communication connections or interfaces, such as network 250. For example, network 250 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL). Particular portions of controller 120, such as the communications device 128, may be in operable communication with network 250, such as to receive or provide instructions, commands, etc. between external device 300 and memory device 124. External device 300 may accordingly command performance of steps of the method at appliance 100.

Communication system 350 is described herein according to an exemplary embodiment of the present subject matter. However, it should be appreciated that the exemplary functions and configurations of communication system 350 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

As generally depicted at FIGS. 1-3, computing device 120, such as a controller configured generally for embodiments of appliance 100 depicted and described herein, is operably coupled to the appliance 100, such as to transmit signals for operation of one or more components of the appliance 100, e.g., imaging devices. Computing device 120 at the appliance 100 is further operably coupled to the imaging device 114 to receive images or corresponding data therefrom. Accordingly, in certain embodiments, computing device 120 is communicatively coupled to transmit and receive signals via network 250 to remote server 200 and external device 300.

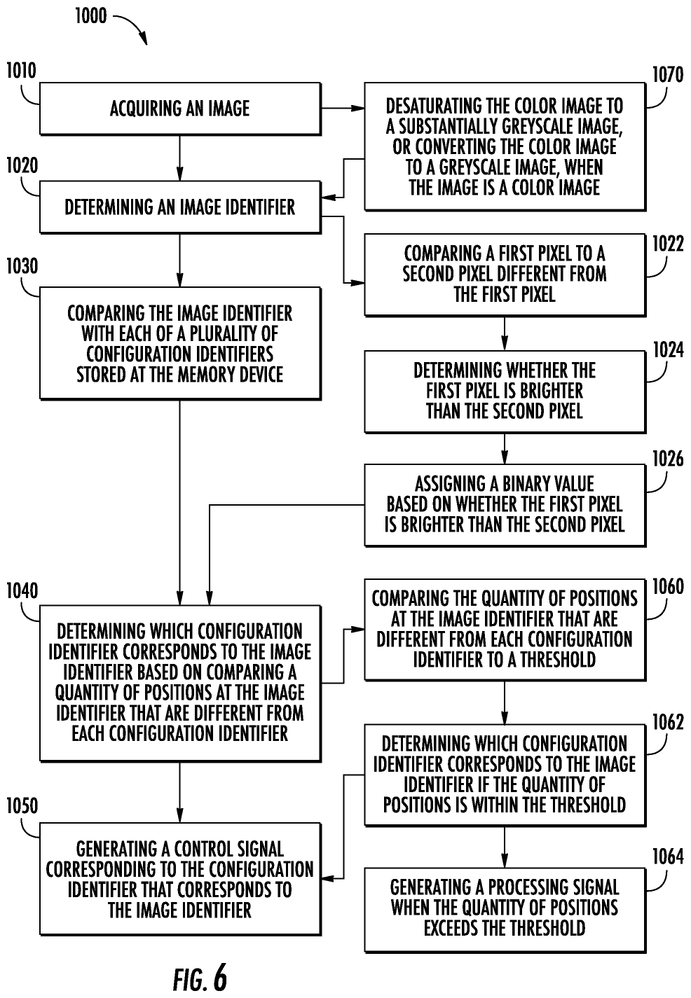

Referring now to FIG. 6, a flowchart outlining exemplary steps of a method for image processing at an appliance is provided (hereinafter, “method 1000”). Steps of method 1000 provided herein may be stored and received at computing device 120, remote server 200, or external device 300, or transmitted between computing device 120, remote server 200, or external device 300, to execute steps at appliance 100. Although steps of method 1000 may be provided in regard to appliance 100 and/or communication system 350 such as depicted and described in regard to FIGS. 1-5, method 1000 may be implemented and executed at any appropriate appliance including rack and rack mount configurations and one or more computing devices.

Referring to FIG. 6, method 1000 includes at 1010 acquiring, via an imaging device (e.g., imaging device 114), an image. In various embodiments, the method 1000 at 1010 includes acquiring an image via an imaging device configured with a field of view including at least a portion of a rack and a rack mount in a chamber of the appliance.

Method 1000 includes at 1020 determining, from the image, an image identifier. The image identifier includes a plurality of alphanumeric characters (i.e., a string of alphabets, numerals, or combinations thereof). Method 1000 includes at 1030 comparing the image identifier with each of a plurality of configuration identifiers stored at the memory device. Method 1000 includes at 1040 determining which configuration identifier corresponds to the image identifier based on comparing a quantity of positions at the image identifier that are different from each configuration identifier.

In various embodiments, determining the image identifier includes determining the image identifier from the image based on a hash function. The hash function may include any function that may be utilized to map data of arbitrary size to fixed-size values, such as hash values, has codes, digests, or hashes. The hash function may be utilized for data storage and retrieval in a relatively small and substantially constant time per retrieval.

In some embodiments, determining the image identifier includes at 1022 comparing a first pixel to a second pixel different from the first pixel, at 1024 determining whether the first pixel is brighter than the second pixel, and at 1026 assigning a binary value based on whether the first pixel is brighter than the second pixel.

In various embodiments, method 1000 at 1030 includes determining a hamming distance between the image identifier and each of a plurality of configuration identifiers stored at a memory device (e.g., memory device 124 at computing device 120 at the appliance 100). In some embodiments, the quantity of positions at the image identifier that are different from each configuration identifier is the hamming distance. The hamming distance between two strings (i.e., the image identifier and the configuration identifier) is the number of positions at which corresponding symbols (i.e., alphanumeric characters) is different from one another. In still some embodiments, method 1000 at 1040 includes determining, based on the hamming distance, which configuration identifier corresponds to the image identifier.

In some embodiments, method 1000 includes at 1050 generating (e.g., at the computing device 114) a control signal corresponding to the configuration identifier that corresponds to the image identifier.

In various embodiments, the method 1000 includes at 1060 comparing the quantity of positions at the image identifier that are different from each configuration identifier to a threshold, and at 1062 determining which configuration identifier corresponds to the image identifier if the quantity of positions is within the threshold. In some embodiments, method 1000 at 1060 includes comparing the hamming distance to a threshold, and at 1062 determining which configuration identifier corresponds to the image identifier if the hamming distance is within the threshold.

In some embodiments, method 1000 includes at 1064 generating, for transmission to a computing network (e.g., from computing device 120 via network 250 to the remote server 200, the external device 300, or both) a processing signal when the quantity of positions exceeds the threshold.

In certain embodiments, the image is a greyscale image or a desaturated image. In various embodiments, method 1000 includes at 1070 desaturating the color image to a substantially greyscale image, or converting the color image to a greyscale image, when the image is a color image.

In an exemplary embodiment of operation of the appliance 100, the imaging device 114 obtains or captures an image of the racks 107, 307 at the chamber 106, 306. The computing device 120 at the appliance 100 receives the image and converts the image into an image identifier, such as a hash (e.g., a 64 bit hash). In some embodiments, the computing device 120 stores a rack configuration table including a plurality of rack configurations (i.e., positionings of the rack 107, 307 at the rack mount 108, 308) at the appliance 100. The plurality of rack configurations corresponds to the plurality of configuration identifiers. The computing device 120 compares the image identifier to a plurality of configuration identifiers stored at the computing device 120 (e.g., at memory device 124). For instance, the image identifier including the hash is compared to pre-determined and labeled configuration identifiers including respective image hashes corresponding to various configurations of rack positions at rack mounts at the appliance 100. The computing device 120 compares the image identifier (e.g., the image hash) to the plurality of configuration identifiers (e.g., pre-determined image hashes) to determine whether and which image identifier substantially matches a configuration identifier corresponding to a particular rack configuration.

An advantage and benefit of the image hash may include identical images having identical hashes. The hamming distance may be calculated between a pair of hashes to determine a similarity between the captured image corresponding to the image identifier and the pre-captured image corresponding to the configuration identifier. The threshold within which the images, or image hashes, are determined to be similar may be pre-determined by a user without undue experimentation. At the appliance 100, the computing device 120 may determine the rack configuration of the rack 107, 307 at the rack mount 108, 308. In certain embodiments, if the hamming distance is beyond the threshold, the computing device 120 generates a processing signal and transmits the processing signal to the remote server 200, the external device 300, or both, such as to further process and determine the rack configuration. The communication system 350 may transmit a cloud control signal to the appliance 100, in which the cloud control signal corresponds to a rack configuration determined at the remote server 200 or external device 300.

Embodiments of the appliance 100 and method 1000 provided herein may reduce or eliminate computing processes in a cloud computing network, such as by computing at the local computing device at the appliance. Such reduction or elimination may reduce costs and process times relative to cloud computing. Additionally, or alternatively, embodiments of the appliance 100 and method 1000 provided herein may utilize the rack configuration, such as the control signal generated at the computing device, to improve heat transfer properties and operational components at the appliance based on the rack configuration, such as to improve thermal efficiency, reduce energy consumption, or improve heat transfer at food stuffs, fluids, objects, etc. at the over chamber, refrigeration chamber, or freezer chamber.

Further aspects of the invention are provided by the subject matter in the following clauses:

1. An appliance, including a plurality of walls forming a chamber; an imaging device configured with a field of view including at least a portion of the chamber; and a controller in operable communication with the imaging device, the controller including a processor operably coupled to a memory device, the memory device configured to store instructions that, when executed by the processor, causes the appliance to perform operations, the operations including acquiring, via the imaging device, an image; determining, from the image, an image identifier including a plurality of alphanumeric characters; comparing the image identifier with each of a plurality of configuration identifiers stored at the memory device; and determining which configuration identifier corresponds to the image identifier based on comparing a quantity of positions at the image identifier that are different from each configuration identifier.

2. The appliance any one or more clauses herein, the operations including generating a control signal corresponding to the configuration identifier that corresponds to the image identifier.

3. The appliance any one or more clauses herein, the operations including comparing the quantity of positions at the image identifier that are different from each configuration identifier to a threshold; and determining which configuration identifier corresponds to the image identifier if the quantity of positions is within the threshold.

4. The appliance of claim 3, the operations including generating, for transmission to a computing network, a processing signal when the quantity of positions exceeds the threshold.

5. The appliance any one or more clauses herein, wherein the image is a greyscale image or a desaturated image.

6. The appliance any one or more clauses herein, the operations including when the image is a color image, desaturating the color image to a substantially greyscale image.

7. The appliance any one or more clauses herein, the operations including when the image is a color image, converting the color image to a greyscale image.

8. The appliance any one or more clauses herein, wherein the quantity of positions at the image identifier that are different from each configuration identifier is a hamming distance.

9. The appliance of any one or more clauses herein, wherein determining the image identifier includes determining the image identifier based on a hash function.

10. The appliance of any one or more clauses herein, wherein determining the image identifier includes comparing a first pixel to a second pixel different from the first pixel; determining whether the first pixel is brighter than the second pixel; and assigning a binary value based on whether the first pixel is brighter than the second pixel.

11. The appliance of any one or more clauses herein, wherein the appliance is an oven appliance, an air fryer appliance, or a microwave oven appliance.

12. The appliance of any one or more clauses herein, wherein the appliance is a refrigeration appliance or a freezer appliance.

13. A system for image processing at an appliance, the system including a controller in operable communication with an imaging device configured with a field of view of at least a portion of a chamber at the appliance, the controller including a processor operably coupled to a memory device, the memory device configured to store instructions that, when executed by the processor, causes the appliance to perform operations, the operations including acquiring, via the imaging device, an image; determining, via a hash function, an image identifier from the image; determining a hamming distance between the image identifier and each of a plurality of configuration identifiers stored at the memory device; and determining, based on the hamming distance, which configuration identifier corresponds to the image identifier.

14. The system of any one or more clauses herein, the operations including comparing the hamming distance to a threshold; and determining which configuration identifier corresponds to the image identifier if the hamming distance is within the threshold.

15. The system of any one or more clauses herein, the operations including generating a processing signal when the quantity of positions exceeds the threshold.

16. The system of any one or more clauses herein, wherein the image is a greyscale image or a desaturated image.

17. The system of any one or more clauses herein, the operations when the image is a color image, converting or desaturating the color image to a substantially greyscale image.

18. A method for image processing at an appliance, the method including acquiring an image; determining an image identifier from the image, the image identifier including a plurality of alphanumeric characters; comparing the image identifier with each of a plurality of configuration identifiers stored at the memory device; and determining which configuration identifier corresponds to the image identifier based on comparing a quantity of positions at the image identifier that are different from each configuration identifier.

19. The method of any one or more clauses herein, the method including comparing the quantity of positions at the image identifier that are different from each configuration identifier to a threshold; and determining which configuration identifier corresponds to the image identifier if the quantity of positions is within the threshold.

20. The method of any one or more clauses herein, the method including comparing a first pixel to a second pixel different from the first pixel; determining whether the first pixel is brighter than the second pixel; and assigning a binary value based on whether the first pixel is brighter than the second pixel.

21. The system of any one or more clauses herein, wherein the system is a computing device.

22. The appliance of any one or more clauses herein, the appliance including the system of any one or more clauses herein.

23. The appliance of any one or more clauses herein, the appliance configured to execute the method of any one or more clauses herein.

24. The system of any one or more clauses herein, the system configured to execute the method of any one or more clauses herein.

25. The appliance of any one or more clauses herein, including one or more racks attachable to at least one position among a plurality of rack mounts within the chamber.

26. The appliance of any one or more clauses herein, wherein the imaging device is configured with a field of view including the one or more racks attachable to the at least one position along the plurality of rack mounts within the chamber.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance, comprising:
a plurality of walls forming a chamber;
an imaging device configured with a field of view including at least a portion of the chamber; and
a controller in operable communication with the imaging device, the controller comprising a processor operably coupled to a memory device, the memory device configured to store instructions that, when executed by the processor, causes the appliance to perform operations, the operations comprising:
acquiring, via the imaging device, an image;
determining, from the image, an image identifier comprising a plurality of alphanumeric characters;
comparing the image identifier with each of a plurality of configuration identifiers stored at the memory device; and
determining which configuration identifier corresponds to the image identifier based on comparing a quantity of positions at the image identifier that are different from each configuration identifier.

2. The appliance of claim 1, the operations comprising:
generating a control signal corresponding to the configuration identifier that corresponds to the image identifier.

3. The appliance of claim 1, the operations comprising:
comparing the quantity of positions at the image identifier that are different from each configuration identifier to a threshold; and
determining which configuration identifier corresponds to the image identifier if the quantity of positions is within the threshold.

4. The appliance of claim 3, the operations comprising:
generating, for transmission to a computing network, a processing signal when the quantity of positions exceeds the threshold.

5. The appliance of claim 1, wherein the image is a greyscale image or a desaturated image.

6. The appliance of claim 1, the operations comprising:
when the image is a color image, desaturating the color image to a substantially greyscale image.

7. The appliance of claim 1, the operations comprising:
when the image is a color image, converting the color image to a greyscale image.

8. The appliance of claim 1, wherein the quantity of positions at the image identifier that are different from each configuration identifier is a hamming distance.

9. The appliance of claim 1, wherein determining the image identifier comprises determining the image identifier based on a hash function.

10. The appliance of claim 1, wherein determining the image identifier comprises:
comparing a first pixel to a second pixel different from the first pixel;
determining whether the first pixel is brighter than the second pixel; and
assigning a binary value based on whether the first pixel is brighter than the second pixel.

11. The appliance of claim 1, wherein the appliance is an oven.

12. The appliance of claim 1, wherein the appliance is a refrigeration appliance or a freezer appliance.

13. A system for image processing at an appliance, the system comprising a controller in operable communication with an imaging device configured with a field of view of at least a portion of a chamber at the appliance, the controller comprising a processor operably coupled to a memory device, the memory device configured to store instructions that, when executed by the processor, causes the appliance to perform operations, the operations comprising:
acquiring, via the imaging device, an image;
determining, via a hash function, an image identifier from the image;
determining a hamming distance between the image identifier and each of a plurality of configuration identifiers stored at the memory device; and
determining, based on the hamming distance, which configuration identifier corresponds to the image identifier.

14. The system of claim 13, the operations comprising:
comparing the hamming distance to a threshold; and
determining which configuration identifier corresponds to the image identifier if the hamming distance is within the threshold.

15. The system of claim 14, the operations comprising:
generating a processing signal when the quantity of positions exceeds the threshold.

16. The system of claim 13, wherein the image is a greyscale image or a desaturated image.

17. The system of claim 13, the operations comprising:
when the image is a color image, converting or desaturating the color image to a substantially greyscale image.

18. A method for image processing at an appliance, the method comprising:
acquiring an image;
determining an image identifier from the image, the image identifier comprising a plurality of alphanumeric characters;
comparing the image identifier with each of a plurality of configuration identifiers stored at the memory device; and
determining which configuration identifier corresponds to the image identifier based on comparing a quantity of positions at the image identifier that are different from each configuration identifier.

19. The method of claim 19, the method comprising:
comparing the quantity of positions at the image identifier that are different from each configuration identifier to a threshold; and
determining which configuration identifier corresponds to the image identifier if the quantity of positions is within the threshold.

20. The method of claim 19, the method comprising:
comparing a first pixel to a second pixel different from the first pixel;
determining whether the first pixel is brighter than the second pixel; and
assigning a binary value based on whether the first pixel is brighter than the second pixel.
